(19) United States
(12) Patent Application Publication
(10) Pub. No.: US 2025/0224995 A1
(43) Pub. Date: Jul. 10, 2025

(54) Optimizing computational model deployment and execution in distributed computing systems

(71) Applicant: HYPERPLANE LTD., Beit Dagan (IL)

(72) Inventor: Shai Tal, Beit Dagan (IL)

(21) Appl. No.: 19/000,760

(22) Filed: Dec. 24, 2024

Related U.S. Application Data
(60) Provisional application No. 63/614,674, filed on Dec. 26, 2023.

(51) Int. Cl. G06F 9/50; G06N 20/00

(52) U.S. Cl. CPC G06F 9/5055; G06N 20/00

(57) ABSTRACT

Methods, computing systems and computer program products implement embodiments of the present invention that include collecting execution metrics for copies of a computational model deployed in respective computing resources, and identifying respective configurations of the computing resources deploying the computational model. A decision model can then be trained based on the collected execution metrics and the identified configurations. A request to execute the computational model is received, the request including cost and performance parameters. The trained decision model is prompted to select, based on the collected execution metrics, the identified configurations and the received parameters, a given computing resource, and finally, execution of the computational model on the selected computing resource is initiated.

### CROSS-REFERENCE TO RELATED APPLICATION

This application claims the benefit of U.S. Provisional Patent Application 63/614, 674, filed Dec. 26, 2023, which is incorporated herein by reference

### FIELD OF THE INVENTION

The present invention relates generally to load balancing, and specifically to training and implementing a decision model configured to select a computing resource to execute a computational model such as an artificial intelligence (AI) model.

### BACKGROUND OF THE INVENTION

In distributed systems such grid computing systems, selecting appropriate nodes for executing applications is a critical task that impacts performance, resource utilization, and system efficiency. A grid comprises heterogeneous nodes with varying processing memory, power, storage, and network capabilities. The selection process must consider these factors to ensure optimal allocation of resources to application requirements. Effective node selection aims to balance workload distribution, minimize execution time, and reduce the potential for bottlenecks.

The selection process typically involves resource discovery, profiling, and matchmaking. Resource discovery identifies available nodes, while profiling gathers details about their specifications and current load. Matchmaking aligns application requirements, such as computational intensity or memory needs, with suitable nodes. This alignment can be enhanced by algorithms that consider criteria like proximity to data sources, reliability, and energy efficiency. Advanced techniques often incorporate predictive models to forecast node performance under expected workloads.

Dynamic environments in grid systems introduce additional challenges, such as node failures or variable network conditions. Adaptive strategies, including real-time monitoring and reallocation mechanisms, help mitigate these issues. Effective scheduling policies that prioritize tasks, fairness, and deadlines for successful application execution. By carefully selecting nodes, grid computing systems can achieve high throughput and scalability while accommodating diverse applications and user demands.

### SUMMARY OF THE INVENTION

There is provided, in accordance with an embodiment of the present invention, a method including collecting execution metrics for copies of a computational model deployed in respective computing resources, identifying respective configurations of the computing resources deploying the computational model, training a decision model based on the collected execution metrics and the identified configurations, receiving a request to execute the computational model, the request including cost and performance parameters, prompting the trained decision model to select, based on the collected execution metrics, the identified configurations and the received parameters, a given computing resource, and initiating execution of the computational model on the selected computing resource.

In some embodiments, the respective computing resources include a subset of a set of computing resources in a distributed computing system, and the method further includes, prior to collecting the execution metrics, computing a distribution for the computational model, and deploying the computational model to the subset of the computing resources in response to the computed distribution.

n one embodiment, the computing resources in the distributed computing system includes first compute nodes configured to execute the computational model, second compute nodes configured to store and to execute the computational model, data nodes configured to store the computational model and one or more cloud services configured to store the computational model, and wherein deploying the computational model in response to the computed distribution includes deploying at least two copies of the computational model a combination of the first compute nodes, the second compute nodes, the data nodes and the one or more cloud services.

In another embodiment, computing the distribution includes collecting performance information of the computational model executing on one or more of the computing resources, training a distribution model based on the collected performance information, and executing the distribution model so as to compute the distribution.

In an additional embodiment, computing the distribution includes collecting, from a time prediction model, predicted performance information of the computational model executing on one or more of the computing resources, training a distribution model based on the collected predicted performance information, and executing the distribution model so as to compute the distribution.

In a further embodiment, the method further includes, prior to computing the distribution, analyzing the AI application so as to compute the predicted performance information executing on the one or more of the computing resources, and training the time prediction model based on the computed predicted performance information.

In a supplemental embodiment, the method further includes, collecting performance information on the computational model executing on at least one of the computing resources, and training the time prediction model based on the computed predicted performance information.

In one embodiment, the computing resources include respective components, the method further includes identifying performance characteristics of the components in one or more of the computing resources, and training the time prediction model based on the identified performance characteristics.

In another embodiment, the computing resources include respective components, the method further includes identifying utilization of the components in one or more of the computing resources, and training the time prediction model based on the identified performance characteristics.

In an additional embodiment, the method further includes computing a size of the computational model, and training the time prediction model based on the computed size.

In a further embodiment, the method further includes computing an average of amounts of time required to load the computational model to one or more computing resources, and training the time prediction model based on the computed average.

In a supplemental embodiment, a given computing resource includes a node processor, the method further includes identifying respective utilizations of the node processor before, during and after executing the computational model, and training the time prediction model based on the identified utilizations.

In some embodiments, the method further includes splitting the computational model into multiple segments, wherein prompting the trained decision model to select a given computing resource includes prompting the trained decision model to select respective computing resources for the segments, and wherein initiating execution of the computational model includes initiating execution of the computational model on the respective computing resources.

In one embodiment, splitting the computational model includes generating sets of independent code segments, computing performance information for the independent code segments, and splitting the model based the computed performance information and the received parameters.

In some embodiments, prompting the trained decision model includes estimating respective execution times of the received computational model on a plurality of the computing resources, analyzing the received computational model so as to generate a set of features, analyzing the plurality of the computing resources so as to generate an additional set of features, and wherein prompting the trained decision model to select the given resource includes modeling the estimated execution times and the received parameters so as to select the given computing resource.

In one embodiment, the method further includes computing a size of the computational model, and wherein a given feature includes a size of the computational model.

In another embodiment, the method further includes identifying a type of the computational model, and wherein a given feature includes the type.

In an additional embodiment, the method further includes identifying a plurality of the computing resources including the computational model, identifying respective utilizations of the identified computing resources, and wherein a given feature includes the respective utilizations.

In a further embodiment, the method further includes identifying a plurality of the computing resources including the computational model, computing respective load time estimates for the computational model on the identified computing resources, and wherein a given feature includes the load time estimates.

In a supplemental embodiment, the method further includes identifying a plurality of the computing resources including the computational model, computing respective execution time estimates for the computational model on the identified computing resources, and wherein a given feature includes the execution time estimates.

In one embodiment, a given node includes a node processor, the method further includes identifying an availability of the node processor, and wherein a given feature includes the identified availability.

In an additional embodiment, the collected execution metrics and the identified configurations include features, wherein selecting a given computing resource based on the collected execution metrics, the identified configurations and the received parameters includes selecting the given computing resource based on the features, wherein collecting the execution metrics includes identifying a size of the computational model, and wherein a given feature includes the identified size.

In a further embodiment, the collected execution metrics and the identified configurations include features, wherein selecting a given computing resource based on the collected execution metrics, the identified configurations and the received parameters includes selecting the given computing resource based on the features, wherein the computing resources include respective storage devices, wherein identifying the respective configurations includes identifying performance characteristics of a given storage device storing the computation model, and wherein a given feature includes the identified performance characteristics.

In a supplemental embodiment, the storage device includes a cloud service, and wherein identifying performance characteristics of the given storage device storing the computation model includes identifying performance characteristics of the cloud service.

In one embodiment, the collected execution metrics and the identified configurations include features, wherein selecting a given computing resource based on the collected execution metrics, the identified configurations and the received parameters includes selecting the given computing resource based on the features, wherein the computing resources include respective storage devices, wherein identifying the respective configurations includes identifying a utilization of a given storage device storing the computation model, and wherein a given feature includes the identified utilization.

In another embodiment, the storage device includes a cloud service, and wherein identifying performance characteristics of the given storage device storing the computation model includes identifying performance characteristics of the cloud service.

In an additional embodiment, the collected execution metrics and the identified configurations include features, wherein selecting a given computing resource based on the collected execution metrics, the identified configurations and the received parameters includes selecting the given computing resource based on the features, wherein the computing resources include respective node memories, wherein collecting the execution metrics includes computing an estimate of an amount of time required to load the computational model to a given memory, and wherein a given feature includes the estimated amount of time.

The method according to claim 1, wherein the collected execution metrics and the identified configurations include features, wherein selecting a given computing resource based on the collected execution metrics, the identified configurations and the received parameters includes selecting the given computing resource based on the features, wherein the computing resources include respective node processors, wherein collecting the execution metrics includes computing an estimate of an amount of time required by a given node processor to execute the computational model, and wherein a given feature includes the estimated amount of time.

In a further embodiment, the collected execution metrics and the identified configurations include features, wherein selecting a given computing resource based on the collected execution metrics, the identified configurations and the received parameters includes selecting the given computing resource based on the features, wherein the computing resources include respective node processors, wherein collecting the execution metrics includes identifying a utilization of a given node processor, and wherein a given feature includes the identified utilization.

In a supplemental embodiment, identifying the utilization includes identifying the utilization of the given node processor prior to executing the computational model.

In one embodiment, identifying the utilization includes identifying the utilization of the given node processor while executing the computational model.

In another embodiment, identifying the utilization includes identifying the utilization of the given node processor subsequent to executing the computational model.

In an additional embodiment, the collected execution metrics and the identified configurations include features, wherein selecting a given computing resource based on the collected execution metrics, the identified configurations and the received parameters includes selecting the given computing resource based on the features, wherein collecting the execution metrics includes identifying a type of the computational model, and wherein a given feature includes the identified type.

In a further embodiment, the collected execution metrics and the identified configurations include features, wherein selecting a given computing resource based on the collected execution metrics, the identified configurations and the received parameters includes selecting the given computing resource based on the features, wherein collecting the execution metrics includes identifying, upon receiving the request, a number of additional computational models waiting for execution on the computing resources, and wherein a given feature includes the identified number.

There is also provided, in accordance with an embodiment of the present invention, an apparatus including a memory configured to store a decision model, and a processor configured to collect execution metrics for copies of a computational model deployed in respective computing resources, to identify respective configurations of the computing resources deploying the computational model, to train a decision model based on the collected execution metrics and the identified configurations, to receive a request to execute the computational model, the request including cost and performance parameters, to prompt the trained decision model to select, based on the collected execution metrics, the identified configurations and the received parameters, a given computing resource, and to initiate execution of the computational model on the selected computing resource.

There is additionally provided, in accordance with an embodiment of the present invention, a computer software product, the computer software product comprising a non-transitory computer-readable medium, in which program instructions are stored, which instructions, when read by a computer, cause the computer to collect execution metrics for copies of a computational model deployed in respective computing resources, to identify respective configurations of the computing resources deploying the computational model, to receive a request to execute the computational model, the request including cost and performance parameters, to train a decision model based on the collected execution metrics and the identified configurations, to prompt the trained decision model to select, based on the collected execution metrics, the identified configurations and the received parameters, a given computing resource, and to initiate execution of the computational model on the selected computing resource.

### BRIEF DESCRIPTION OF THE DRAWINGS

The disclosure is herein described, by way of example only, with reference to the accompanying drawings, wherein:

FIG. 1 is a block diagram showing an example of a computing facility comprising a set of computing resources and a model deployment server, in accordance with an embodiment of the present invention;

FIG. 2 is a block diagram showing an example configuration of a given computing resource, in accordance with a first embodiment of the present invention;

FIG. 3 is a block diagram showing an example configuration of a given computing resource, in accordance with a second embodiment of the present invention;

FIG. 4: block diagram showing an example configuration of the model deployment server, in accordance with a first embodiment of the present invention;

FIG. 5 is a flow diagram that schematically illustrates a method of deploying a computational model to the computing resources and selecting one of the computing resources to execute the computational model, in accordance with an embodiment of the present invention;

FIG. 6 is a flow diagram that schematically illustrates a method of training a time prediction model that predicts execution time of the computational model on different computing resources, in accordance with an embodiment of the present invention;

FIG. 7 is a flow diagram that schematically illustrates a method of training a decision model to select a given computing resource to execute the computational model, in accordance with an embodiment of the present invention;

FIG. 8 is a flow diagram that schematically illustrates a method of distributing the computational model on a set of the computing resources, in accordance with an embodiment of the present invention; and

FIG. 9 is a flow diagram that schematically illustrates a method of segmenting the computational model, in accordance with an embodiment of the present invention.

### DETAILED DESCRIPTION OF EMBODIMENTS

Utilization of computing resources in managed cloud services is typically low due to high costs. As a result of these high costs, individuals and enterprises typically limit usage of these computing resources for resource-intensive workloads such as deep learning and machine learning systems, which if deployed more efficiently, would provide substantial benefits to the individual or enterprise.

Embodiments of the present invention provide methods and systems for training and deploying a decision model that can be used to optimize, in cloud computing systems, caching of a resource intensive workloads, such as computational models. In embodiments described hereinbelow, optimizing caching comprises computing where to deploy and execute computational models in a distributed computing system such as a cloud-based grid computing system. These embodiments can then be used to select an optimal computing resource on which to execute, such as a computational model.

As described hereinbelow, execution metrics are collected for copies of a computational model deployed in respective computing resources, and respective configurations of the computing resources deploying the computational model identified. A decision model is trained based on the collected execution metrics and the identified configurations.

A request is received to execute the computational model, the request comprising cost and performance parameters. Upon receiving the request, the trained decision model is prompted to select, based on the collected execution metrics, the identified configurations and the received parameters, a given computing resource, and execution of the computational model can be initiated on the selected computing resource.

In some embodiments, the parameters may also include configuration and utilization of the computing resource, and the decision model can be trained to select an optimal computing resource based on the parameters. In a first additional embodiment described hereinbelow, a distribution model can be employed to identify n optimal distribution of the computational model among the computing resources. In a second additional embodiment, a segmentation model can be used to identify how to optimally split the computational model into multiple segments that can be deployed and executed on multiple computing resources.

Therefore, systems implementing embodiments of the present invention can help optimize the utilization of computing resources by (a) splitting computational models into multiple segments, (b) optimizing the distribution of computational models (i.e., complete non-segmented computational models) or the respective segments of the computational models, and (c) selecting an optimal computing resource on which to execute a complete (i.e., not segmented computational model) or a given segment of an computational model.

### SYSTEM DESCRIPTION

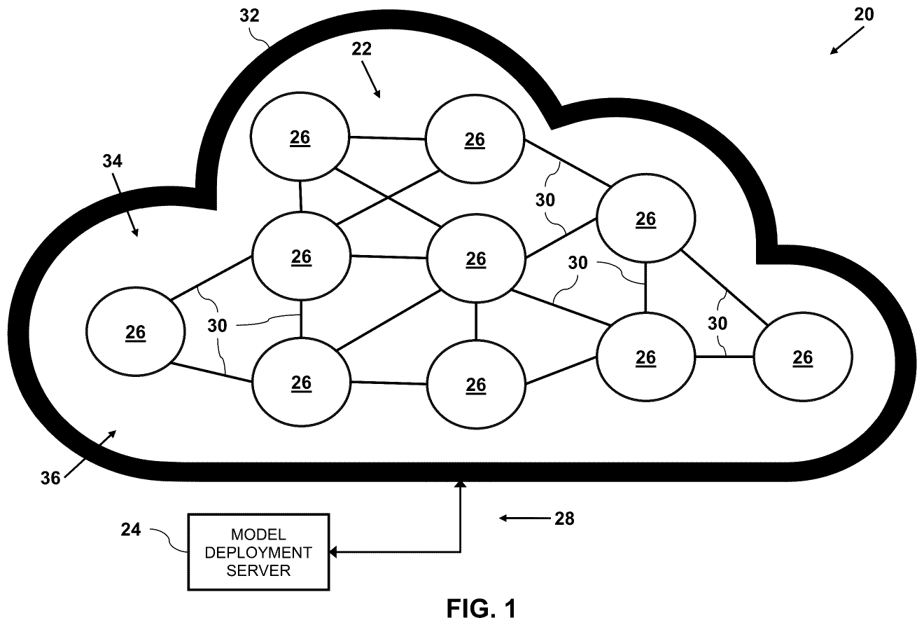

FIG. 1 is a block diagram showing a computing facility 20, in accordance with an embodiment of the present invention. In the configuration shown in FIG. 1, computing facility 20 comprises a grid computing system 22 that can communicate with a model deployment server 24 over a public data network such as Internet 28.

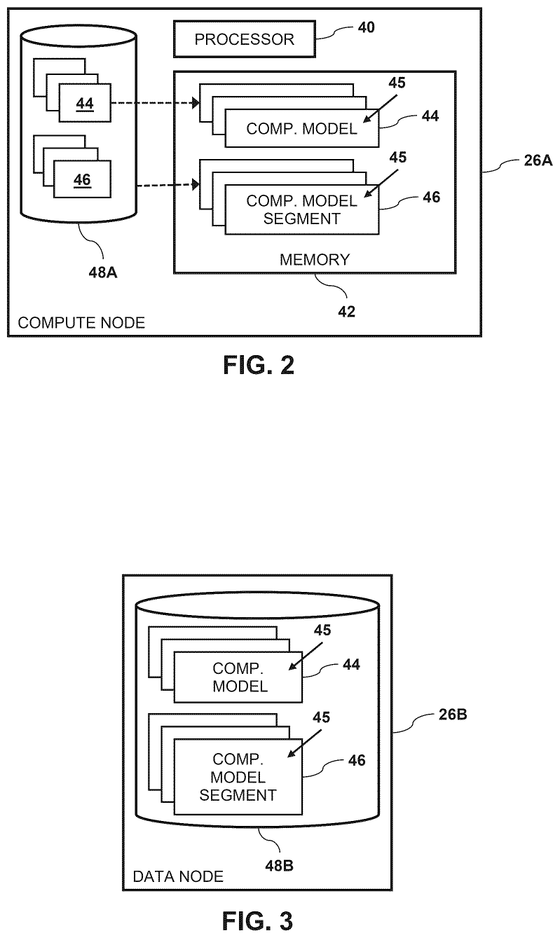

Grid computing system 22 may comprise a set of grid nodes 26 that can communicate with each other over network connections 30. Example configurations of grid nodes 26 are described in the description referencing FIGS. 2 and 3 hereinbelow.

In some embodiments, grid computing system 22 can be deployed by a managed cloud service 32 that can provide additional computing and/or cloud (e.g., storage) services 34. An example of a given storage service 32 is SIMPLE STORAGE SERVICE™ (S3™), provided by provided by AMAZON.COM, INC., 410 Terry Avenue North, Seattle, WA, USA.

Computing facility 20 can be configured to deploy a system 36 that is described in the description referencing FIG. 3 hereinbelow.

FIGS. 2 and 3 show example configurations of gride nodes 26, in accordance with an embodiment of the present invention. In some embodiments, each gride node 26 may comprise a node processor 40, a node memory 42 and a node storage device 48.

In embodiments described herein, grid nodes 26 can be configured to store and/or execute one or more computational models 44 comprising code 45. Code 45 comprises program instructions that can execute on processors 40. Computational models 44 typically comprise simplified representations of real-world systems, processes, or phenomena, designed to be analyzed and simulated using mathematical and computational techniques. They can involve breaking down complex systems into constituent parts, defining their relationships and interactions, and translating these into mathematical equations or algorithms that can be executed on a computer.

In some embodiments as described hereinbelow, a given computational model 44 can split into multiple computational model segments 46 that also comprise code 45. In these embodiments, grid nodes 29 can be configured to store and/or execute one or more computational model segments 46. Examples of computational models 44 include, but are not limited to, AI models such as large language models (LLMs), neural network models, and deep learning models.

In FIGS. 2 and 3, grid nodes 26 and their respective components can be differentiated by appending a letter to the identifying numeral, so that the grid nodes comprise a compute node 26A and a data node 26B (referred to herein collectively as grid nodes 26), and the storage devices comprise storage devices 48A and 48B (referred to herein collectively as storage devices 42).

In grid computing system 22, data nodes 26B and compute nodes 26A can serve distinct roles to enable distributed processing. Data nodes 26B are typically responsible for storing and managing (i.e., for computations) computational models 44 and computational model segments 46. The data nodes ensure data availability, reliability, and scalability by storing replicated models 44 and segments 46 across multiple data nodes 26B to prevent loss and support parallel access.

In contrast, compute nodes 26A are typically dedicated to performing the actual computations and processing tasks using models 44 and segments 46 provided by data nodes 26B. Compute nodes 26A can rely on their processing power, such as CPUs or GPUs, to execute jobs distributed across grid computing system 22, often working collaboratively to solve large-scale problems. The coordination between the data and the compute nodes enables efficient resource utilization, with data nodes 26B ensuring swift access to data and compute nodes 26A focusing on computation operations.

In the configuration shown in FIG. 2, a given compute node 26A may comprise a node processor 40 and a node memory 42 that can store computational models 44 and/or computational model segments 46. In one embodiment, processor 40 can load, from a given data node 26A or from a given service 34, a given computational model 44 or a given computational model segment memory 42, and then execute the loaded computational model/computational model segment from the node memory.

In an alternative embodiment, given compute node 26 may further comprise a given local storage device 48A configured to store one or more computational models 44 and/or one or more computational model segments 46. In this alternative embodiment, processor 40 can load, from local storage device 48A into memory 42, a given computational model 44 or a given computational model segment 46, and then execute the loaded computational model/computational model segment from the node memory.

In the configuration shown in FIG. 3, a given data node 26B may comprise a node storage device 48B that is configured to store one or more computational models 44 and/or one or more computational model segments 46.

As described supra, computing facility 20 can be configured to deploy system 36. In some embodiments system 36 comprises single or multiple copies of computational models 44 and/or computational model segments 46 distributed among nodes 26 and/or one or more services 34.

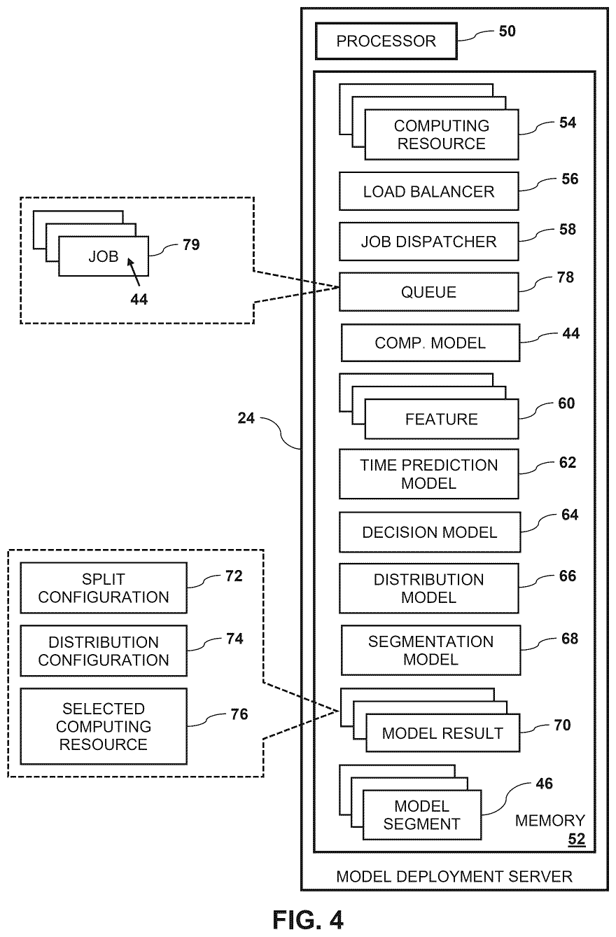

FIG. 4 is a block diagram showing an example configuration of model deployment server 24, in accordance with an embodiment of the present invention. In the configuration shown in FIG. 4, model deployment server 24 comprises a server processor 50 and a server memory 52 that can be configured to store a set of computing resources 54, a load balancer 56, a job dispatcher 58, a given computational model 44, a set of features 60, a time prediction model 62, a decision model 64, a distribution model 66, a segmentation model 68, a set of model results 70, and a set of computational model segments 46.

In some embodiments, memory 52 may comprise a queue 78 that stores a plurality of jobs 79. Each job 79 may comprise a given computational model 46 to be deployed and executed in a distributed computing system such as grid computing system 22. In an alternative embodiment (not shown), a given job 79 may comprise a given computational model segment 46 to be deployed and executed in grid computing system 22.

In embodiments described hereinbelow, processor 50 can execute models 62, 64, 66 and 68 so as to generate one or more configurations 70 in response to analyzing a given computational model 44. In some embodiments, each model result 70 can store information such as:
A split configuration 72 indicating how to split the given computational model into multiple computational model segments 46.
A distribution configuration 74 indicating how to distribute the given computational model and/or the multiple computational model segments (i.e., of the given computational model) across nodes 26 and/or services 34.
A selected computing resource 76 indicating, in response to an analysis, where to execute the given computational model or a given computational model segment 46.

Load balancer 56 executes on processor 50, and is configured to distribute incoming network traffic or service requests across multiple services 34 and/or nodes 26 to ensure that no single service 34 or node 26 becomes overwhelmed. In some embodiments, in response to distribution configuration 74, load balancer 56 can select which nodes 26 and/or services 34 to provision and start.

When analyzing a given computational model 44 or a given computational model segment 46, processor 50 can extract and/or generate a set of features 60. As described hereinbelow, models 62, 64, 66 and 68 can use features 60 when making their respective decisions.

Each computing resource 54 references a given compute node 26A on which processor 50 can deploy (i.e., for execution) a given computational model 44 and/or a given computational model segment 46. In some embodiments, a given computing resource 54 may additionally reference a given data node 26B and/or a given service 34.

Decision model 64 executes on processor 50, and can be configured to generate a result comprising a given computing resource 54 on which to execute a given computational model 44 or a given computational model segment 46. Upon generating the result, decision model 64 can store the generated result to selected computing resource 76.

In some embodiments, processor 50 can train decision model 64 to maximize a value function (e.g., a value function that is maximized when the total time of execution is minimal, or when the total amount of jobs done per time unit is maximal). The model may comprise/utilize, for example, additional models such as prediction model 62, an optimization model, a search model, a reinforcement learning model.

Decision model 64 may, for example, be any kind of decision-making model, that can be (a be based on any kind of value function or inputs, (b) a general computational model such as search and optimization, or (c) a machine learning-based model such as like reinforcement learning and prediction.

In examples of features 60 described herein, a given job 79 may refer to a given computational model 44 or a given computational model segment 46 in the given job. In some embodiments, processor 50 can model (i.e., analyze) the model features so as to identify an optimal resource 54 on which to execute a given model 44 or 46.

Processor 50 can identify/compute model features 60 based on collected execution metrics of models 44/46 that executed on resources 54, and (identified) configurations of the computing resources. Examples of model features 60 (i.e., inputs/metrics) to decision model 64 for a given job 79 include, but are not limited to execution metrics (i.e., of models 44 and 46) and configuration information for resources 54, such as:
A size of the given job (e.g., in megabytes/gigabytes).
Performance characteristics (i.e., speeds and/or capacities) of storage devices 48 and/or services 34 that store the given job.
The respective utilizations of storage devices 48 and/or services 34 in the computing resources that store the given job.
Respective estimated times required to load the given job to the node memory in each of the compute nodes to which the given job is distributed (i.e., per configuration 74).
Respective estimated times required to execute the given job by the node processors in each of the compute nodes to which the given job is distributed (i.e., per configuration 74).
Respective estimated utilizations (i.e., before, during and after executing the given job) of each of the node processors in each of the compute nodes to which the given job is distributed (i.e., per configuration 74).
A type of the given job. In some embodiments, the type may indicate a type of the computational model in the given job (e.g., a deep learning model or an LLM). In additional embodiments the type may indicate a model type that a human can understand, or can be a cluster or a category that the computational model (i.e., in the given job) has concluded and does not necessarily carry a human understandable name.
A number of jobs 70 in queue 78. Each job 60 may comprise an additional model 44/64 queued (i.e., waiting to be) executed in a given computing resource 54.

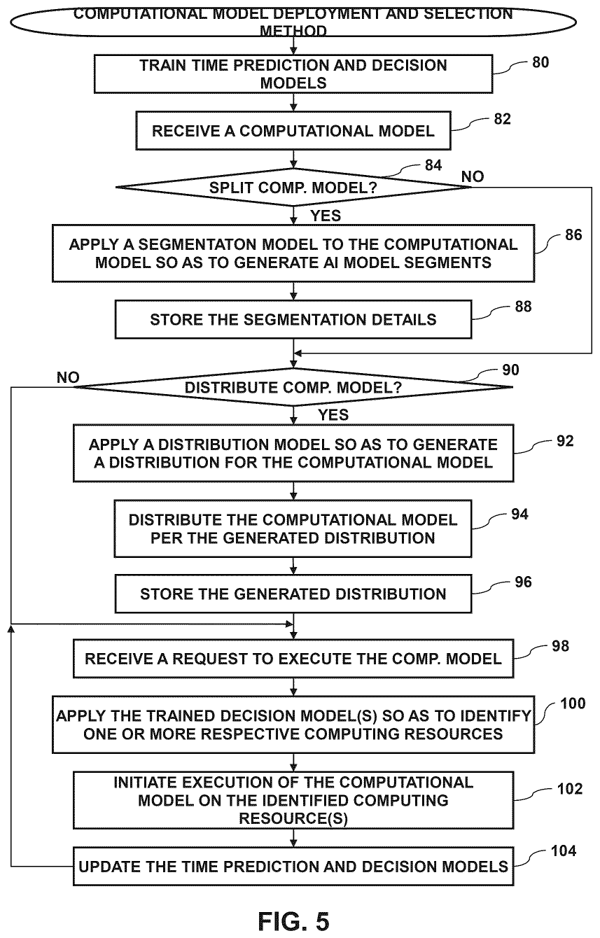

Deploying trained decision model 64 is described in the description referencing FIG. 5 hereinbelow.

Job dispatcher 58 executes on processor 50, and is responsible for assigning jobs 79 to available nodes 26 and/or services 34 in grid computing system 22. In embodiments herein, in response to selected computing resource 76, job dispatcher 58 can “instruct” a given computing resource 54 (i.e., referenced by the selected computing resource) to execute an instance of a given computational model 44 or an instance of a given computational model segment 46.

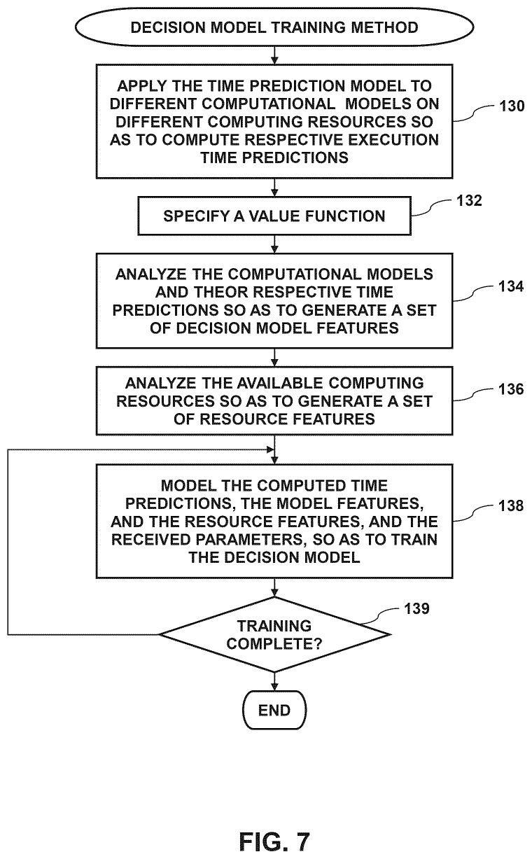

In some embodiments, processor 50 can optimize decision model 64 by applying various AI techniques based on the inputs and outputs to the decision model. Those optimization techniques can include machine learning models, reinforcement learning models, simulations, and other optimization techniques. The steps of training the decision model and steps described in the description referencing FIG. 7 hereinbelow may be considered to be a first phase of a process for optimizing decision model 64 based on a monetary value (e.g., a cost such as computing resource cost) and/or an amount of time required to time to load a given computational model (i.e., from a given storage device 48 or a given service 34) to a given memory 44.

Time prediction model 62 executes on processor 50, and is configured to predict an amount of time (e.g., in seconds) a given job 79 requires to load (i.e., from a given storage device 48 or a given service 34 into a given memory 42) and/or to execute (i.e., on a given processor 40). In some embodiments, time prediction model 62 may comprise a machine learning (ML) model, an computational model, a reinforcement learning (RL) model, a deep learning (DL) model and a statistical optimization model.

Examples of resource features 60 (e.g., input parameters) that processor 50 can compute/identify/collect for training time prediction model 62, based on a given job 79 executing on a given computing resource 54, include, but are not limited to:
Respective performance characteristics (i.e., speeds and/or capacities) of components such as storage devices 48, memories 42 and/or services 34 storing the given job.
Performance characteristics (i. e., speeds and/or capacities) of components (e.g., processors 40, memories 42, services 34, and storage devices 48A) in the given computing resource.
Current utilization of components in the given computing resource.
A size (e.g., in kilobytes, megabytes, or gigabytes) of the given job.
Respective average times to load, from different storage devices 48 and/or services 34, the given job the node memory of the compute node in the given computing resource.
An availability of processor 40 in the compute node of the given computing resource. The availability can indicate whether the given computing resource is currently available (i.e., it can be “is this machine available to compute now” it can be “how busy is this machine now”.An estimate of an amount of time required to execute the given job on the compute node of the given computing resource.
A utilization metric for system 36.
A utilization, before/during/after executing the given job, of processor 40 in the compute node of the given computing resource.
A metered time indicating an amount of time the computational model in the given job required to run (i.e., previously) on one or more computing resources 54. Additionally or alternatively, the metered time may indicate a measurement of how much of a different given computing resource 54 (i.e., “computing horsepower”) the given job required (i.e., when executing previously on the one or more computing resource.

In some embodiments, time prediction model 62 may comprise a classic machine learning model, a deep learning model, a reinforcement learning model, a statistic model, or any type of computational model that is able to produce relevant results. These types of models can be implemented as, for example, an XGBoost model, a neural network model and a linear regression model.

In some embodiments, distribution model 66 executes on processor 50 and addresses how models 44 and/or 46 are distributed across compute nodes 26A, data nodes 26B and services 34 in computing facility 29. Distribution model 66 may comprise modeling such techniques as simulation and computational modeling. In some embodiments, distribution model 66 can be further improved using feedback from decision model 64. Thus, two different customers/scenarios may yield two very different distribution configurations 74.

In some embodiments, segmentation model 68 executes on processor 50, and can be configured to divide computational models 44 into dividing into multiple model segments 46. In these embodiments, segmentation model 68 can store the individual model segments in caching levels (i.e., different nodes 26 and/or services 34). This division is useful in cases where a given computational model 44 is large, and/or multiple computational models 46 share respective parts (i.e., code segments 46).

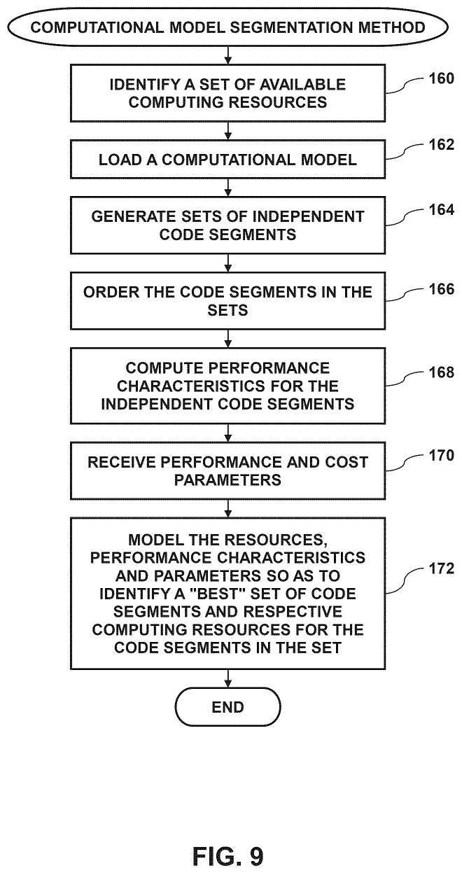

As described in the description referencing FIG. 9 hereinbelow, upon splitting a given computational model 44 into multiple computational model segments 46, segmentation model 68 can use time prediction model 62 so as to predict time implications of different configurations of distributing the computational model segments in system 36. For example, segmentation model 68 can use experimental methods that test actual setups, by simulating distributions, such as by using prediction methods (e.g., machine learning, reinforcement learning, artificial intelligence, and deep learning). These and the like. The simulations can analyze caching implications or loading implications of the different potential model splitting.

Potential features 60 that segmentation model 68 can use to find the best split are, for example, the size of computational model segments 46, the probability for dependency between the computational model segments, waits, blocks, data transfer between the computational model segments, and their respective sizes.

As described hereinbelow, input to segmentation model 68 may comprise, for example, a given computational model 64 and features 60 for nodes 26 and services 34. Output of segmentation model 68 may comprise, for example, relevant points for program division, probabilities of dependency, and needed waits. Features 60 nodes 26 and services 34 are described hereinbelow.

When segmentation model 68 analyzes a given split (i.e., a set of computational model segments 46), the segmentation model can analyze split points in code 45 and probabilities (i.e., for dependency), and potentially dynamic information about the system 34 (i.e., different configurations of nodes 26 and services 34 and their respective availabilities). Output from segmentation model 68 may comprise, for example, an optimal split of computational model 44, and respective nodes 26 and/or services on which to store and execute the computational model segments (i.e., of the optimal split).

For example, upon segmentation model 68 dividing a given computational model 44 into multiple computational model segments 46, the computational model segments 46 may be queued as respective jobs 79, which can be arranged sequentially (or not), and fed back into the segmentation model 68 so as to compute an optimal deployment and execution in system 36.

In one embodiment, segmentation model 68 can split a given computational model 44 into multiple computational model segments 46, and then determine whether the computational model segments may be executed on a single computed node 26A (i.e., as a constraint).

In some embodiments, segmentation model 68 may comprise a compiler (not shown) that can analyze a given computational model 44 so as to identify to find spots in code 45 where a “split point” may be created. There may be many potential split points, and in order to determine whether to use a split point, and which of them to use, segmentation model 68 can simulate implications of their respective execution times in system 36.

Examples of features 60 for system 36 include, but are not limited to.
Speed, estimated lifespan, purchase cost, execution cost (e.g., maintenance, allocated overhead in facility 20, electricity costs) and current utilization of processors 40 and network connections 30.
Speed, size, estimated lifespan, purchase cost, execution cost (e.g., maintenance, allocated overhead in facility 20, electricity costs) and current utilization of memories 42 and storage devices 48.
Speed, size and service cost of services 34.

Processors 40 and 50 comprise one or more general-purpose central processing units (CPU) or special-purpose embedded processors, which are programmed in software or firmware to carry out the functions described herein. This software may be downloaded to grid nodes 26 and model deployment server 24 in electronic form, over a network, for example. Additionally or alternatively, the software may be stored on tangible, non-transitory computer-readable media, such as optical, magnetic, or electronic memory media. Further additionally or alternatively, at least some of the functions of processors 40 and 50 may be carried out by hard-wired or programmable digital logic circuits.

In some embodiments, processors 40 may comprise specialized hardware optimized to execute computational models 44 and computational model segments 46 (i.e., at different speeds). Examples of this type of specialized hardware include, but are not limited to, graphics processing units (GPUs) and field-programmable gate arrays (FPGAs). Typically, the costs of processors 40 are directly proportional to their respective speeds.

Examples of memories 42, 52 and storage devices 48 include dynamic random-access memories, non-volatile random-access memories, hard disk drives and solid-state disk drives.

In some embodiments, memories 42 may comprise specialized hardware that can be optimized to enable processor 40 to execute computational models 44 and computational model segments 46 at different speeds. Examples of this type of specialized hardware include random access memory (RAM) and GPU memory. Typically, the costs of memories 40 are directly related to their respective speeds, wherein, for example, GPU memory is typically faster and more expensive than RAM.

In additional embodiments, storage devices 42 and services 34 may comprise specialized hardware that can be optimized to enable processor 40 to load computational models 44 and computational model segments 46 at different speeds. Typically, the costs of storage devices are directly proportional to their respective speeds. Examples of storage devices in order of their respective speeds (i.e., from slower to faster) include but are not limited to: may range.
Hard disk drives (HDDs) and network storage.
Solid state disks (SSDs) and non-volatile memory express (NVMe) disks.
Random access memory (RAM).
GPU memory.

For example, load times (i.e., from a given storage device 48 to a given memory 42) for a given computational model 44 (or a given computational model segment 46) may be approximately:
10 milliseconds (MS) when loaded from GPU Memory.
100 MS when loaded from RAM.
1000 MS when loaded from an SSD.
2000 MS when loaded from an HDD.

In further embodiments, network connections 30 may comprise different hardware/software configurations that enable compute nodes 26A and data nodes 26B to communicate with each other at different speeds (or components within grid nodes to communicate with each other at a different speeds. Typically the costs of network connections 30 are directly related to their respective speeds, wherein, for example, InfiniBand network connections are typically faster and more expensive than Ethernet network connections.

In some embodiments, tasks described herein performed by grid nodes 26 and model deployment server 24 may be split among multiple physical and/or virtual computing devices. In other embodiments, these tasks may be performed in managed cloud service 32.

### AI MODEL DEPLOYMENT AND EXECUTION

FIG. 5 is a flow diagram that schematically illustrates a method of analyzing, deploying and selecting a given computational model 44, in accordance with an embodiment of the present invention.

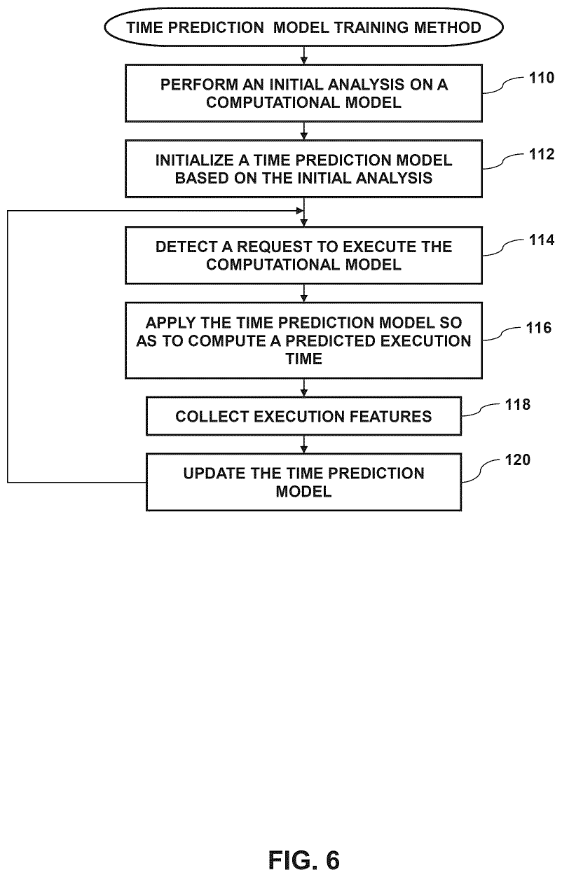

In step 80, processor 50 trains time prediction model 62 and decision model 64. Training time prediction model 62 is described in the description referencing FIG. 6 hereinbelow. Training decision model 64 is described supra and in the description referencing FIG. 7 hereinbelow.

In step 82, processor 50 receives, and loads to memory 52, a given computational model 44 for analysis.

In step 84, if processor 50 receives a request to split the received computational model into multiple computational model segments 46, then in step 86, the server processor applies segmentation model 68 to the received computational model so as to split the received computational model into multiple computational model segments 46. Applying segmentation model 68 to the received computational model is described in the description referencing FIG. 9 hereinbelow.

In step 88, in response to splitting the received computational model into multiple computational model segments 66, processor 50 stores, to split configuration 72, a configuration referencing the multiple AI segments for the received computational model.

In step 90, if processor receives a request to distribute the received computational model, then in step 92, the server processor applies distribution model 66 to the received computational model so as to generate/compute a distribution of copies the received computational model among at least two nodes 26 and/or services 34. In embodiments where processor 50 split the received computational model into multiple computational model segments 46, the server processor can apply distribution model 66 to each of the computational model segments (i.e., of the received computational model) so as to generate respective distributions for the computational model segments.

In step 94, processor 50 can distribute the received computational model or its computational model segments in response to the generated distribution(s).

In step 96, processor 50 can store a configuration of the distribution(s) (e.g., which nodes 26 and/or services 34 store the received computational model or its respective model segments 46) to distribution configuration 74.

In step 98, processor 50 receives a request to execute the received computational model. In some embodiments, the request can include request parameters such as performance requirements, cost requirements, a type (e.g., similar the type of a given job described in the description of features 60 for a given job 79 as described hereinabove) for the received model, where the received model is stored in grid computing system 22 (i.e., indicating retrieval speeds from storage devices 48A, data nodes 26B or services 34), available compute nodes 26A and their respective configurations (i.e., processors 40, memories 42 and network connections 30), respective utilization of the available compute nodes, and respective prediction times for execution of the received computational model (and possibly other computational models deployed in grid computing system 22) on the available compute nodes.

Prior to executing step 98, the received computational model was distributed among multiple grid nodes 26, and the multiple grid nodes executed the received computational model. Typically, the grid nodes on which the received computation model is distributed. Processor 50 can collect execution features 60 (e.g., execution times on different grid nodes 26) by analyzing the respective executions of the received computational model. Additionally, processor 50 can identify respective configurations of grid nodes 26 and generate resource features 60 based on the configurations.

In step 100, processor 50 prompts (i.e., executes the trained) decision model 64 so as to identify/select, in response to the received parameters, a “best” (i.e., optimal) computing resource 54 that can be used to execute the received computational model. In embodiments where the received computational model comprises a set of computational model segments 46, processor 50 can execute decision model 64 so as to identify, in response to the received parameters, respective “best” computing resources 54 (i.e., that can load the requested computational model) that can be used to execute the computational model segments in the set.

In step 102 processor 50 initiates execution of the received computational model on the identified computing resource (or the computational model segments of the received computational model on the respective identified computing resources.

In step 104, processor 50 generates (i.e., collects) performance features 60 (as described in the description referencing FIG. 6 hereinbelow), and updates time prediction model 62 and decision model 64 with the generated features, and the method returns to step 114.

In some embodiments using the received cost parameter can be used to optimize revenue for computing facility 20. For example, processor 50 receives, from a first client, a request to execute a first computational model 64, and receives, from a second client, second request to execute a second computational model 64. In the event the first client pays a higher fee than the second client (i.e., for resource usage), decision model 64 can be configured to select respective computing resources 54 for the first and the second computational models in order to maximize revenue. A result of this may be prioritizing the first request so as to select a “faster” computing resource 54 to execute the first computational model.

Returning to step 90, if processor does not receive a request to distribute the received computational model, then the model continues with step 98. In one embodiment, processor 50 may have previously stored the received computational model to a given service 34 such as S3™ which can independently optimize storage and distribution of the received computational model. In this embodiment, decision model 64 can identify a best compute node 26A for executing the received computational model.

Returning to step 84, if processor 50 does not receive a request to split the received computational model into multiple computational model segments 46, then the method continues with step 90.

FIG. 6 is a flow diagram that schematically illustrates a method of training time prediction model 62, in accordance with an embodiment of the present invention.

In step 110, processor 50 performs an initial analysis of computational models 44 so as to compute respective estimates of their load and execution times on computing resources 54. For example, processor 50 can execute an expert knowledge algorithm in order to compute execution time estimates for computational models 44 on different computing resources 54.

In step 112, processor 50 initializes (i.e., initially trains) time prediction model 62 based on the computed estimates. When training and executing time prediction model 62 processor 50 can provide features 60 such as performance specifications of components in computing resource 54 (e.g., processors 40, memories 42, storage devices 48, network connections 30 and services 34).

In step 114, processor 50 detects a request to execute a given computational model 44 on a given computing resource 54 in computing facility 20.

In step 116, processor 50 applies time prediction model 62 to the request so as to compute an estimated load and execution time for the given computational model on the given computing resource. In some embodiments, processor 50 may input, to time prediction model 62, additional features 60 such network traffic on network connections 30 and utilization of processor on the node processor executing the given computational model.

In step 118, upon detecting the given computational model completing its execution on the given computing resource, processor 50 collects/generates/computes/identifies further execution features 60 for the given computational model that executed on the given computing resource. In some embodiments, processor 50 can model (i.e., analyze) these features (i.e., in addition to the resource features described supra) so as to generate time predictions for models 44 on resources 54. Examples of these features, include, but are not limited to:
A size of the given computational model.
Performance characteristics of a given storage device 48 or a given service 34 that stored the given computational model.
An amount of time required to load the given computational model to the node memory in the compute node of the given computing resource.
An average amount of time required to load, from storage devices 48 and/or services 34, the given computational model to the node memories of different the compute nodes.
an amount of time required to execute the given computational model on the node processor in the compute node of the given computing resource.
Utilization of hardware components of the given computing resource (e.g., a given node processor 40 in a given compute node 26A, and one or more network connections 30) prior to, during, and subsequent to executing the given computational model.
Performance characteristics of components of the given computing resource (e.g., a given processor 40, a given memory 42, a given storage device 48, a given service 34, and one or more network connections 30).

In step 120, processor 50 updates time prediction model 62 with the collected execution features, and the method continues with step 114.

Note that steps 110 and 112 are optional. Training time prediction model can begin with step 114, i.e., when computational models 44 are deployed (i.e., “production”) for execution in computing facility 20

While steps 110-120 described hereinabove described embodiments for training time prediction model 62 for predicting respective execution times of computational models 44 on computing resources 54, using these embodiments for training the time prediction model for predicting respective execution times of computational model segments 46 on the computing resources is considered to be within the spirit and scope of the present invention.

FIG. 7 is a flow diagram that schematically illustrates a method of training decision model 64, in accordance with an embodiment of the present invention.

In step 130 processor 50 applies time prediction model 62 to different combinations of computational models 44 on different computing resources 54 so as to compute respective execution time estimates (i.e., for each given combination comprising a given computational model 44 and a given computing resource 54). Processor 50 can generate features 60 for training time prediction mode; 62 based on these collected/computed time estimates and their respective computing resources.

In step 132, processor 50 specifies a value function to be maximized when training decision model 64.

In step 134, processor 50 analyzes computational models 44 and their respective time estimates computed in step 130 so as to generate model features 60 for decision model 64.

In step 136, processor 50 analyzes computing resources 54 so as to generate computing resource features 60 for decision model 64. Examples of features 60 for decision model 64 are described supra.

In step 138, processor 50 models, using embodiments described supra, the computed time predictions and the generated features (i.e., the resource and the decision model features) so as to train decision model 64.

In step 139, processor 50 detects whether training decision model 64 is complete. As described supra, processor 50 can train decision model so as to maximize the value function specified in step 132. In some embodiments, any combination of model deployment server 24 and/or compute nodes 26A can detect the value function is maximized if the server processor detects a minimal change (i.e., below a specified threshold) in the value function in successive iterations.

If processor 50 detects completion of training decision model 64, then the method ends. However, if processor 50 detects that training decision model 64 is not complete, then the method continues with step 138

While steps 130-139 described hereinabove described embodiments for training decision model 64 for computational models 44 on computing resources 54, using these embodiments for training the decision for computational model segments 46 on the computing resources is considered to be within the spirit and scope of the present invention.

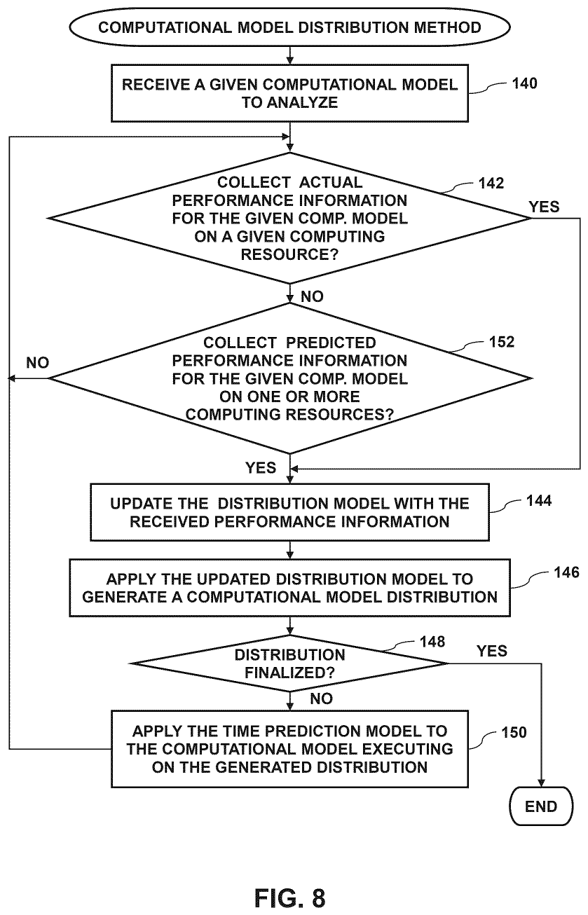

FIG. 8 is a flow diagram that schematically illustrates a method of applying distribution model 66 to a given computational model 44 so as to generate a given distribution configuration 74, in accordance with an embodiment of the present invention.

In step 140, processor 50 receives a given computational model 44 to analyze so as to generate the given distribution configuration.

In step 142, if processor 50 collects actual performance information for the given computational model executing on a given computing resource 54, then in step 144, processor 50 updates distribution model 66 with the received performance information and features 60 of the given computing resource. Features 60 for computing resources 54 are described supra.

In step 146, processor 50 applies the updated distribution model so as to generate distribution configuration 74.

In step 148, processor 50 checks if distribution configuration 74 is finalized. Identifying whether distribution configuration 74 is finalized is described hereinbelow.

In step 150, processor 50 applies time prediction model 62 to the given computational model on computing resources 54 in distribution configuration 54, and the method continues with step 142.

Returning to step 142, if processor 50 does not receive actual performance information for the given computational model executing on a given computing resource 54, then in step 152, if processor 50 collects, from time prediction model 62, predicted performance information comprising a predicted execution time for the received model on a given computing resource, then the method continues with step 144. step.

However, in step 152, if processor 50 does not receive, from time prediction model 62, predicted performance information comprising a predicted execution time for the received model on a given computing resource, then the method continues with step 142.

To check if distribution configuration is finalized, processor 50 can compare distribution configuration 74 in the current iteration (i.e., steps 142-152) to the distribution configuration in the previous iteration. In some embodiments processor 50 can classify distribution configuration 74 as finalized if the distribution configuration in the current iteration is identical to the distribution configuration in the previous iteration. Likewise, processor 50 can classify distribution configuration 74 as not finalized if the distribution configuration in the current iteration is different than the distribution configuration in the previous iteration.

For purposes of visual simplicity, steps 142 and 152 are shown executing sequentially. In some embodiments, steps 142 and 152 can execute in parallel on processor 50 and update distribution model 74 (i.e., as shown in step 144) accordingly.

The steps described hereinabove (i.e., for FIG. 8) can be used, for example, to optimize system 36, such that the total value of execution of the workloads that are being run on the system is maximized. The executed workloads may originate with one or more users, with or without specific constraints.

Additionally, these steps can be designed to decide nodes 26 and/or services 34 on which to store models 44 and/or 46, and the number of duplications for each model 44 and/or 46 such that the total value of the system execution is maximized, (e.g., maximizing the number of models 44 and/or 46 that can be executed, maximizing revenue, minimizing latency in computing facility 20, etc.)

For example, the method described in FIG. 8 may be performed in two phases comprising (a) looking for potential system topologies (i.e., step 150 and step 142), and (b) checking or simulating their value in order to make a decision (i.e., steps 146 and 148). Both of these phases can be, for example, AI/ML based. Also, for example, the first phase can use a search algorithm, such as random restart hill climbing/reinforcement learning, and the second phase may check or simulate real-world results, such as by predicting expected values using a machine learning prediction model, or by validating real world results and collecting feedback.

While steps 140-152 described hereinabove described embodiments for applying distribution model 66 to a given computational model 44 SO as to generate distribution configuration 74 for the given computational model in computing facility 20, applying the distribution model to a given computational model segment 46 so as to generate distribution configuration 74 for the given computational model segment in computing facility 20 is considered to be within the spirit and scope of the present invention.

FIG. 9 is a flow diagram that schematically illustrates a method of applying segmentation model 68 to a given computational model 44 so as to generate a set of computational model segments 46, in accordance with an embodiment of the present invention.

In step 160, segmentation model 68 (i.e., executing on processor 50) identifies a set of computing resources 54.

In step 162, segmentation model 68 loads a given computational model 44.

In step 164, segmentation model 68 generates a plurality of sets of independent code segments 46. In other words, (a) no two sets are identical, and (b) the code segments in each set comprises code 45 in the given AI application.

In step 166, for each given set, segmentation model 68 orders the code segments (e.g., in order of potential execution) in the given set. This can ensure that a first given code segment 46 preceding (i.e., in the order) a second given code segment 46 does not comprise code 45 that is dependent on the code in the second given code segment.

In step 168, segmentation model 68 computes features 60 comprising performance characteristics (i.e., execution time estimates based on time prediction model 62) for all the independent code segments.

In step 170, segmentation model 68 receives cost and performance parameters (e.g., for a customer using computing facility 20).

Finally in step 172, segmentation model 68 models (performance) features 60 of computing resources 54, the computed performance characteristics for computational model segments 46, and the received parameters so as to identify a given (i.e., best/optimal) set of the code segments, and the method ends. In some embodiments, segmentation model 68 can also identify the best/optimal computing resources 54 on which to deploy the computational model segments in the identified set.

As described hereinabove, processor 50 can train models 62, 64, 66 and 68 during a training (time) period and/or deploy these models during a production period (typically a time period subsequent to the training period). During the training time period each of these models can be considered to be in a training state, and once deployed (i.e., during production), each of these models can be considered to be in a production state, The term production typically references a state when these models are already operational, as opposed to the training state when these models not operational.

Nevertheless, even when each of these models is in a production state, processor 50 can enhance these models by performing ad-hoc training and improvement in the forms of active learning, online learning, reinforcement learning, re-training and any additional technique that allows for improving these models while operational. There may also instances when requests (i.e., during production) may also be sent (i.e., by processor 50 to these models) to complete re-training and then be versioned and tested with Red/Black, canary, A/B testing, and any additional method of version control and monitoring if needed.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method, comprising:
collecting execution metrics for copies of a computational model deployed in respective computing resources;
identifying respective configurations of the computing resources deploying the computational model;
training a decision model based on the collected execution metrics and the identified configurations;
receiving a request to execute the computational model, request comprising cost and performance parameters;
prompting the trained decision model to select, based on the collected execution metrics, the identified configurations and the received parameters, a given computing resource; and
initiating execution of the computational model on the selected computing resource.

2. The method according to claim 1, wherein the respective computing resources comprise a subset of a set of computing resources in a distributed computing system, and further comprising, prior to collecting the execution metrics, computing a distribution for the computational model, and deploying the computational model to the subset of the computing resources in response to the computed distribution.

3. The method according to claim 2, wherein the computing resources in the distributed computing system comprises first compute nodes configured to execute the computational model, second compute nodes configured to store and to execute the computational model, data nodes configured to store the computational model and one or more cloud services configured to store the computational model, and wherein deploying the computational model in response to the computed distribution comprises deploying at least two copies of the computational model a combination of the first compute nodes, the second compute nodes, the data nodes and the one or more cloud services.

4. The method according to claim 2, wherein computing the distribution comprises collecting performance information of the computational model executing on one or more of the computing resources, training a distribution model based on the collected performance information, and executing the distribution model so as to compute the distribution.

5. The method according to claim 2, wherein computing the distribution comprises collecting, from a time prediction model, predicted performance the information of computational model executing on one or more of the computing resources, training a distribution model based on the collected predicted performance information, and executing the distribution model so as to compute the distribution.

6. The method according to claim 5, and further comprising, prior to computing the distribution, analyzing the AI application so as to compute the predicted performance information executing on the one or more of the computing resources, and training the time prediction model based on the computed predicted performance information.

7. The method according to claim 5, and further comprising, collecting performance information on the computational model executing on at least one of the computing resources, and training the time prediction model based on the computed predicted performance information.

8. The method according to claim 5, wherein the computing resources comprise respective components, and further comprising identifying performance characteristics of the components in one or more of the computing resources, and training the time prediction model based on the identified performance characteristics.

9. The method according to claim 5, wherein the computing resources comprise respective components, and further comprising identifying utilization of the components in one or more of the computing resources, and training the time prediction model based on the identified performance characteristics.

10. The method according to claim 5, and further comprising computing a size of the computational model, and training the time prediction model based on the computed size.

11. The method according to claim 5, and further comprising computing an average of amounts of time required to load the computational model to one or more computing resource, and training the time prediction model based on the computed average.

12. The method according to claim 5, wherein a given computing resource comprises a node processor, and further comprising identifying respective utilizations of the node processor before, during and after executing the computational model, and training the time prediction model based on the identified utilizations.

13. The method according to claim 1, and further comprising splitting the computational model into multiple segments, wherein prompting the trained decision model to select a given computing resource comprises prompting the trained decision model to select respective computing resources for the segments, and wherein initiating execution of the computational model comprises initiating execution of the computational model on the respective computing resources.

14. The method according to claim 13, wherein splitting the computational model comprises generating sets of independent code segments, computing performance information for the independent code segments, and splitting the model based on the computed performance information and the received parameters.

15. The method according to claim 1, wherein prompting the trained decision model comprises estimating respective execution times of the received computational model on a plurality of the computing resources, analyzing the received computational model so as to generate a set of features, analyzing the plurality of the computing resources so as to generate an additional set of features, and wherein prompting the trained decision model to select the given resource comprises modeling the estimated execution times and the received parameters so as to select the given computing resource.

16. The method according to claim 15, and further comprising computing a size of the computational model, and wherein a given feature comprises a size of the computational model.

17. The method according to claim 15, and further comprising identifying a type of the computational model, and wherein a given feature comprises the type.

18. The method according to claim 15, and further comprising identifying a plurality of the computing resources comprising the computational model, identifying respective utilizations of the identified computing resources, and wherein a given feature comprises the respective utilizations.

19. The method according to claim 15, and further comprising identifying a plurality of the computing resources comprising the computational model, computing respective load time estimates for the computational model on the identified computing resources, and wherein a given feature comprises the load time estimates.

20. The method according to claim 15, and further comprising identifying a plurality of the computing resources comprising the computational model, computing respective execution time estimates for the computational model on the identified computing resources, and wherein a given feature comprises the execution time estimates.

21. The method according to claim 15, wherein a given node comprises a node processor, and further comprising identifying an availability of the node processor, and wherein a given feature comprises the identified availability.

22. The method according to claim 1, wherein the collected execution metrics and the identified configurations comprise features, wherein selecting a given computing resource based on the collected execution metrics, the identified configurations and the received parameters comprises selecting the given computing resource based on the features, wherein collecting the execution metrics comprises identifying a size of the computational model, and wherein a given feature comprises the identified size.

23. The method according to claim 1, wherein the collected execution metrics and the identified configurations comprise features, wherein selecting a given computing resource based on the collected execution metrics, the identified configurations and the received parameters comprises selecting the given computing resource based on the features, wherein the computing resources comprise respective storage devices, wherein identifying the respective configurations comprises identifying performance characteristics of a given storage device storing the computation model, and wherein a given feature comprises the identified performance characteristics.

24. The method according to claim 23, wherein the storage device comprises a cloud service, and wherein identifying performance characteristics of the given storage device storing the computation model comprises identifying performance characteristics of the cloud service.

25. The method according to claim 1, wherein the collected execution metrics and the identified configurations comprise features, wherein selecting a given computing resource based on the collected execution metrics, the identified configurations and the received parameters comprises selecting the given computing resource based on the features, wherein the computing resources comprise respective storage devices, wherein identifying the respective configurations comprises identifying a utilization of a given storage device storing the computation model, and wherein a given feature comprises the identified utilization.

26. The method according to claim 25, wherein the storage device comprises a cloud service, and wherein identifying performance characteristics of the given storage device storing the computation model comprises identifying performance characteristics of the cloud service.

27. The method according to claim 1, wherein the collected execution metrics and the identified configurations comprise features, wherein selecting a given computing resource based on the collected execution metrics, the identified configurations and the received parameters comprises selecting the given computing resource based on the features, wherein the computing resources comprise respective node memories, wherein collecting the execution metrics comprises computing an estimate of an amount of time required to load the computational model to a given memory, and wherein a given feature comprises the estimated amount of time.

28. The method according to claim 1, wherein the collected execution metrics and the identified configurations comprise features, wherein selecting a given computing resource based on the collected execution metrics, the identified configurations and the received parameters comprises selecting the given computing resource based on the features, wherein the computing resources comprise respective node processors, wherein collecting the execution metrics comprises computing an estimate of an amount of time required by a given node processor to execute the computational model, and wherein a given feature comprises the estimated amount of time.

29. The method according to claim 1, wherein the collected execution metrics and the identified configurations comprise features, wherein selecting a given computing resource based on the collected execution metrics, the identified configurations and the received parameters comprises selecting the given computing resource based on the features, wherein the computing resources comprise respective node processors, wherein collecting the execution metrics comprises identifying a utilization of a given node processor, and wherein a given feature comprises the identified utilization.

30. The method according to claim 29, wherein identifying the utilization comprises identifying the utilization of the given node processor prior to executing the computational model.

31. The method according to claim 29, wherein identifying the utilization comprises identifying the utilization of the given node processor while executing the computational model.

32. The method according to claim 29, wherein identifying the utilization comprises identifying the utilization of the given node processor subsequent to executing the computational model.

33. The method according to claim 1, wherein the collected execution metrics and identified configurations comprise features, wherein selecting a given computing resource based on the collected execution metrics, the identified configurations and the received parameters comprises selecting the given computing resource based on the features, wherein collecting the execution metrics comprises identifying a type of the computational model, and wherein a given feature comprises the identified type.

34. The method according to claim 1, wherein the collected execution metrics and the identified configurations comprise features, wherein selecting a given computing resource based on the collected execution metrics, the identified configurations and the received parameters comprises selecting the given computing resource based on the features, wherein collecting the execution metrics comprises identifying, upon receiving the request, a number of additional computational models waiting for execution on the computing resources, and wherein a given feature comprises the identified number.

35. An apparatus method, comprising:
a memory configured to store a decision model; and
a processor configured:
to collect execution metrics for copies of a computational model deployed in respective computing resources,
to identify respective configurations of the computing resources deploying the computational model,
to train a decision model based on the collected execution metrics and the identified configurations,
to receive a request to execute the computational model, the request comprising cost and performance parameters,
to prompt the trained decision model to select, based on the collected execution metrics, the identified configurations and the received parameters, a given computing resource, and
to initiate execution of the computational model on the selected computing resource.

36. A computer software product, the computer software product comprising a non-transitory computer-readable medium, in which program instructions are stored, which instructions, when read by a computer, cause the computer:
to collect execution metrics for copies of a computational model deployed in respective computing resources;
to identify respective configurations of the computing resources deploying the computational model;
to receive a request to execute the computational model, the request comprising cost and performance parameters;
to train a decision model based on the collected execution metrics and the identified configurations;
to prompt the trained decision model to select, based on the collected execution metrics, the identified configurations and the received parameters, a given computing resource; and
to initiate execution of the computational model on the selected computing resource.
